(19) United States
(12) Patent Application Publication
(10) Pub. No.: US 2014/0373777 A1
(43) Pub. Date: Dec. 25, 2014

(54) Labeling Unit for Containers

(71) Applicant: KRONES AG, Neutraubling (DE)

(72) Inventors: Josef Scheck, Mintraching (DE); Christian Stoiber, Michelsneukirchen (DE); Robert Scheibenpflug, Pfatter (DE)

(73) Assignee: KRONES AG, Neutraubling (DE)

(21) Appl. No.: 14/292,503

(22) Filed: May 30, 2014

(30) Foreign Application Priority Data
Jun. 25, 2013 (DE) 10 2013 212 126.1

(51) Int. Cl. B05C 1/08

(52) U.S. Cl. CPC B05C 1/08
USPC 118/258

(57) ABSTRACT

A labeling unit having a vertically displaceable motor, a vertically displaceable upper cover plate for a pallet drum as well as a shift linkage which couples the upper cover plate to the motor such that, when the motor is displaced upwards, the pallet drum is lifted together therewith. The motor and the cover plate can thus be lifted in an ergonomically advantageous manner by means of a common operating mechanism on the comparatively easily accessible motor, when a change of format is executed.

### CROSS-REFERENCE TO RELATED APPLICATION

The present application claims priority to German Application No.102013212126.1, filed Jun. 25, 2013. The priority application, DE 102013212126.1, is hereby incorporated by reference.

### FIELD OF THE DISCLOSURE

The present disclosure relates to a labeling unit for containers, in particular a cold-glue labeling unit.

### BACKGROUND

On filling lines for beverage bottles or the like, a change of label formats normally necessitates an exchange of the gluing drums and gluing pallets of cold-glue labeling units. To this end, it is first necessary to lift, e.g. on pallet drums, an upper cover plate with bearings for the gluing pallet shafts, so that the gluing pallets can then be removed from the pallet drum with their drive shafts. Lifting the cover plate is, however, often difficult, since the pallet drum is not fully accessible to the operator and since, due to the tight fit tolerances demanded, the cover plate can only be removed upwards with substantial expenditure of energy.

In comparison with conventional shaft-hub connections, it proved to be advantageous to couple the gluing drum such that it can be removed from the labeling unit to the side, so that the gluing drum can be exchanged. The comparatively heavy gluing drum is then manually removed, e.g. from an upper shaft end of the drive unit positioned therebelow, by pulling it off upwards, and taken out to the side. The manual lifting of the gluing drum is, however, still unfavorable from an ergonomic point of view.

Hence, there is a need for a labeling unit which allows gluing drums and/or gluing pallets to be exchanged under improved ergonomic conditions and with little expenditure of time.

### SUMMARY OF THE DISCLOSURE

The posed task is solved by a labeling unit comprising a gluing drum; a vertically displaceable motor for driving the gluing drum; a pallet drum with an upper cover plate that is adapted to be lifted upwards; and a shift linkage by means of which the cover plate is coupled to a housing section of the motor such that, when the motor is displaced upwards, the cover plate is lifted together therewith.

The cover plate is preferably configured for supporting gluing pallet shafts. This means that gluing pallet shafts provided in the pallet drum have their upper ends rotatably supported in/on the cover plate. For retrofitting the labeling unit, the upper ends of the gluing pallet shafts can be exposed such that it is possible to remove the gluing pallet shafts with the gluing pallets. Through the connection of the cover plate according to the present invention, the cover plate can be raised with the aid of the shift linkage on the output side, especially with a straight vertical lift movement. When the cover plate is lowered and thus ready for operation, the gluing drum and the pallet drum cooperate with a gripper cylinder in the usual way.

Preferably, the shift linkage is configured such that the upper cover plate can be raised from a lower operating position for supporting gluing pallet shafts to an upper retrofitting position for exchanging the gluing pallet shafts. During lifting and decoupling of the motor from the gluing drum, the cover plate can be raised to such an extent that bearings provided on the cover plate can be pulled off the gluing pallet shafts, whereby the latter are released. The exchange of the gluing drum and the gluing pallets will then only necessitate a lift movement on the comparatively easily accessible motor. In the lower operating position of the cover plate, the pallet shafts are rotatably supported in/on the cover plate in a manner known per se.

Preferably, the shift linkage comprises a first rotary bolt, which is coupled to the motor so as to convert a stroke (lift movement) of the motor into a rotary movement of the shift linkage. The conversion into a rotary movement facilitates the support of the shift linkage, the transmission of forces to the cover plate and a possibly desired lift transmission ratio. In particular a rotation about a shaft axis orthogonal to the stroke (lift movement) of the rotary bolt is of advantage. The torque can thus be transmitted more easily in a lateral direction into an area above the upper cover plate.

The first rotary bolt has preferably formed thereon a switching roller which engages a guide groove formed on the motor. The guide groove can be formed on a housing section of the motor as a control curve of adequate shape with little manufacturing effort. The shape of the guide groove can be adapted in a flexible manner to a desired conversion movement of the rotary bolt and the lift movement executed by the motor.

The shift linkage preferably comprises a second rotary bolt which is coupled to the cover plate so as to convert the rotary movement of the shift linkage into a stroke (lift movement) of the upper cover plate. The torque can thus easily be converted into a lifting force. The torque can be transmitted e.g. with the aid of a shaft supported on the motor in a stationary manner.

The first and the second rotary bolts preferably differ from one another with respect to effective lever lengths and/or absolute rotary positions of the levers. A lift transmission ratio from the first rotary bolt to the second rotary bolt can be accomplished in this way.

The effective lever lengths and/or the absolute rotary positions of the levers will then preferably differ such that the second rotary bolt executes a stroke (lift movement) that is smaller than that of the first rotary bolt. The stroke (lift movement) of the upper cover plate required for an exchange of the gluing pallets is normally smaller than the stroke (lift movement) of the motor required for an exchange of the gluing drum. The force for lifting the upper cover plate that is necessary at the first rotary bolt can be reduced by transmitting the lift movements.

The second rotary bolt is preferably coupled to the upper cover plate by means of vertically guided lifting rods. The vertical lifting force can be transmitted to the cover plate in this way. The upper cover plate can thus be lifted more easily in the axial direction of the pallet drum.

According to a preferred embodiment, the second rotary bolt can be pushed beyond a reversal point such that, at a lower reversal point, at which the cover plate is at a lower operating position, the lifting rods change from a downward directed partial stroke (negative partial lift movement) to an upward directed partial stroke (positive partial lift movement). In other words, the cover plate can first be pushed fully downwards, down to and into the operating position, by the downward directed partial stroke, and then the lifting rods can be mechanically decoupled from the cover plate, which rotates during operation, by the upward directed partial stroke. The reversal point of the lift movement can be created by a suitable lever position of the second rotary bolt relative to the lever position of the first rotary bolt. At the lower operating position of the motor, the two levers will then preferably define respective acute angles with opposite signs with the vertical.

Preferably, the upper cover plate has secured thereto a switching disk, which is coaxial with respect to the pallet drum and which is provided with a circumferentially extending groove, and the lifting rods have secured thereto switching cams engaging said groove and/or a connection flange engaging said groove so as to transmit a lifting force to the switching disk. This allows the switching cams and/or the connection flange to engage the switching disk irrespectively of the rotary position of the pallet drum and the upper cover plate. In addition, the lift movement can easily be transmitted by the switching cams and/or the connection flange to an upper contact surface of the groove. The groove may e.g. extend along a circle on the outer circumference of the switching disk and may be open in a radial direction. The groove may, however, also be open downwards, e.g. on a mushroom-shaped switching disk. The switching cams may also be replaced by switching rollers.

According to a preferred embodiment, the switching cams then have a certain amount of vertical clearance in the groove, especially such that the switching cams can move freely at a lowered operating position of the upper cover plate. This will reduce or prevent wear during the operation of stationary switching cams on the switching disk, which rotates together with the pallet drum when in operation. This applies equally to connection flanges and switching cams.

A particularly advantageous embodiment of the labeling unit according to the present disclosure additionally comprises a third rotary bolt for adjusting the vertical position of the motor. The motor is preferably secured in position above the gluing drum. By means of a rotary bolt, the motor can easily be lifted so as to separate a torque-transmitting connection between the motor and the associated gluing drum. In particular, a rotary bolt can be used for generating in an ergonomically advantageous manner a lifting force required for lifting the motor and the cover plate of the pallet drum by a rotary movement of an adequately dimensioned lever.

According to a preferred embodiment, the third rotary bolt then comprises an eccentric with a switching roller which engages a guide groove formed on the motor. The guide groove can be formed easily on a suitable housing section of the motor, e.g. by subjecting the housing section to milling or by securing thereto a rail or the like comprising the guide groove. The eccentric may be secured to a support structure of the motor.

Preferably, the third rotary bolt is formed on motor side located opposite the shift linkage. This allows an ergonomically advantageous position of the third rotary bolt. Furthermore, loads occurring on the housing sections of the motor when the third rotary bolt is operated and when the lift movement of the first rotary bolt is transmitted can thus be distributed in an advantageous manner to opposite sides of the motor and can thus be approximately balanced.

According to a preferred embodiment, the motor is adapted to be displaced upwards from an operating position above the gluing drum, in particular linearly in a vertical direction. The motor is in particular displaceable upwards until it arrives at a retrofitting position for removing the gluing drum. The support of the motor above the gluing drum facilitates a removal of the gluing drum to the side, e.g. by lifting and/or tilting the gluing drum away from a splined drive coupling. The motor is then supported e.g. on a vertical linear guide. This facilitates decoupling of the motor from the gluing drum. The vertical linear guide also allows a precise force transmission of the first rotary bolt for driving the shift linkage.

### BRIEF DESCRIPTION OF THE SEVERAL VIEWS OF THE DRAWINGS

A preferred embodiment of the lifting unit according to the present invention is shown in the drawing, in which:

FIG. 1 shows a partial view of the labeling unit according to the present disclosure;

FIG. 2 shows a partial view of the labeling unit according to the present disclosure;

FIG. 3 shows a fragmentary sectional view through the labeling unit according to the present disclosure;

FIG. 4 shows a partial view in the lowered condition of the motor; and

FIG. 5 shows a partial view in the raised condition of the motor.

### DETAILED DESCRIPTION OF THE PREFERRED EMBODIMENTS

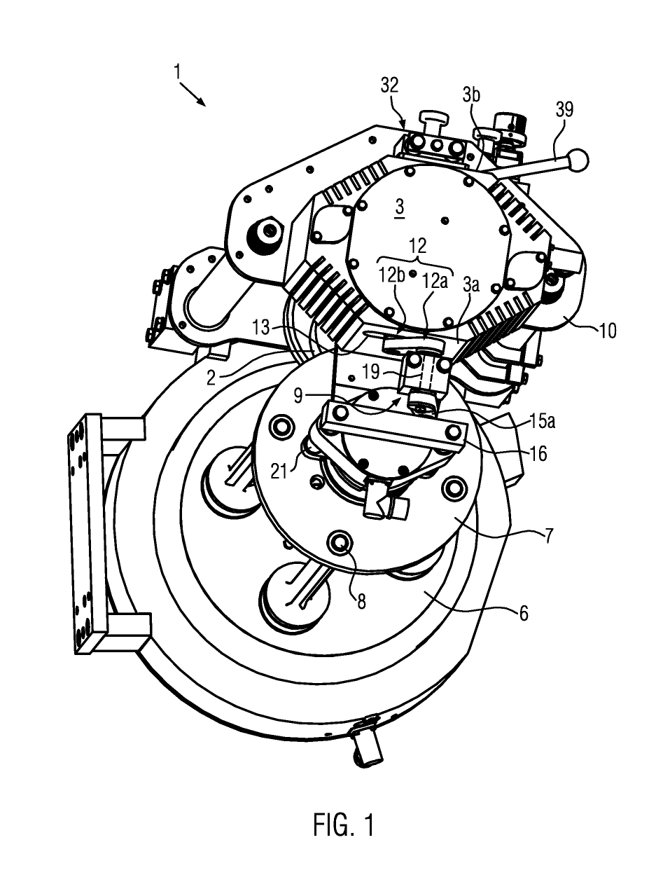

As can be seen from FIGS. 1 to 3, the labeling unit 1 according to the present disclosure, which is e.g. a cold-glue labeling unit for beverage bottles or the like, comprises according to a preferred embodiment a gluing drum 2 and a motor 3 for continuously driving the gluing drum 2. The motor 3 is supported above the gluing drum 2. The drive torque for the gluing drum 2 is transmitted by means of a schematically outlined splined coupling 4, which allows the gluing drum 2 to be removed, e.g. by lateral tilting, when the motor 3 has been lifted by a first stroke 5.

The labeling unit 1 additionally comprises a pallet drum 6 continuously rotatable about a vertical axis 6′ and provided with an upper cover plate 7 for supporting gluing pallet shafts 8 and a shift linkage 9, which mechanically couples the upper cover plate 7 to a first housing section 3a of the motor 3. The motor 3 and the pallet drum 6 are supported on a common frame 10. The way in which the gluing drum 2 and the pallet drum 6 cooperate, when the labeling unit 1 is in operation, with components, such as gripper cylinders, used for handling the containers to be labeled and the labels is known and will not be explained in detail hereinbelow.

The shift linkage 9 comprises a first rotary bolt 12 with a first lever 12a and a first switching roller 12b, which engages a first guide groove 13 formed on the motor 3. This guide groove 13 may be configured as a recess in the first housing section 3a and/or secured in position on the first housing section 3a in the form of guide rails or the like. The first rotary bolt 12 converts the vertical first stroke 5 of the motor 3 into a rotary movement 14.

The shift linkage 9 additionally comprises a second rotary bolt 15 with a second lever 15a and a second switching roller 15b, which engages a guide groove or recess 17 formed in a yoke 16. The first lever 12a and the second lever 15a are connected in a torque-transmitting manner by means of a shifting shaft 19 and/or a gear unit (not shown). The second rotary bolt 15 converts the rotary movement 14 into a vertical second stroke 20 of the cover plate 7, which is preferably smaller than the associated first stroke 5 of the motor 3.

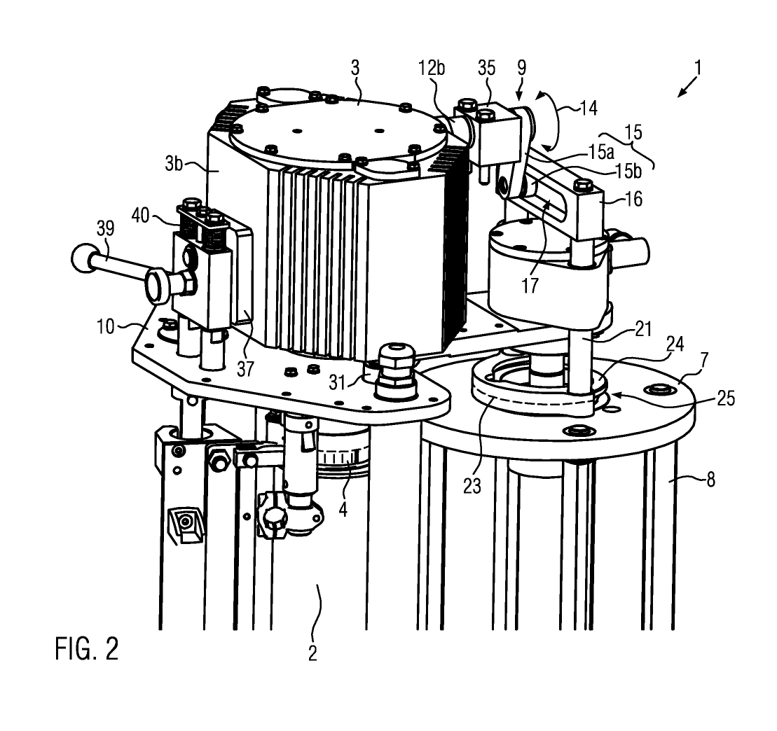

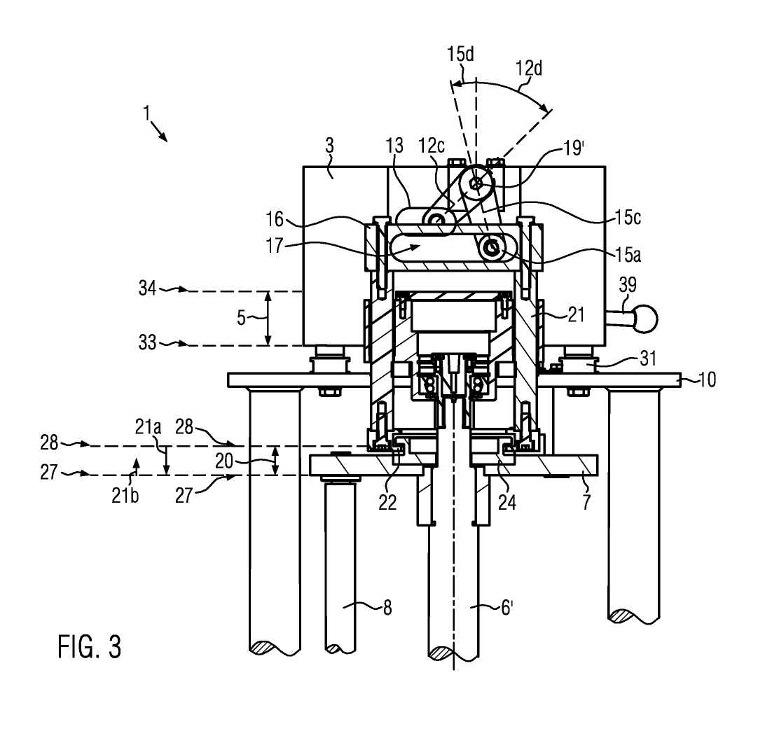

As is clearly shown in particular in FIG. 3, the yoke 16 has secured thereto two lifting rods 21 that are linearly guided in the vertical direction. At the lower end of each lifting rod 21 a respective switching cam 22 is formed for transmitting an upwardly directed lifting force to a switching disk 24 which is fixedly connected to the cover plate 7. Also switching rollers, which are supported such that they are rotatable about a horizontal axis, (not shown) or a circumferentially extending connection flange 23, which is schematically outlined in FIG. 2, may be formed as elements that correspond functionally to the switching cams 22.

The upper cover plate 7 is shown in a lower operating position 27, at which the pallet shafts 8 are supported in the cover plate 7. According to the present disclosure, the cover plate 7 can be raised by the second stroke 20 to an upper retrofitting position 28 above the pallet shafts 8 so that the pallet shafts 8 can be removed for replacing gluing pallets secured thereto. At the lower operating position 27 the pallet drum 6 cooperates with a label gripper cylinder (not shown) in the usual way.

The substantially cylindrical switching disk 24 has formed therein a circumferential groove 25, which opens radially outwards and which can be engaged by the switching cams 22 and/or the connection flange 23 from the side, irrespectively of the rotary position of the switching disk 24. The groove 25 is preferably higher than the switching cams 22 and/or the connection flange 23, so that said switching cams 22 and/or connection flange 23 have a certain amount of vertical clearance in the groove 25 in the lowered condition of the cover plate 7. When the cover plate 7 and the switching disk 24 fixedly connected thereto have been fully lowered to the lower operating position 27, the switching cams 22 and/or the connection flange 23 are preferably not in contact with the inner wall of the groove 25. The switching cams 22 and/or the connection flange 23 will then freely circulate in the groove 25 during normal operation of the pallet drum 6, so as to prevent wear of the switching cams 22, the connection flange 23 and the groove 25.

During normal operation of the pallet drum 6, the pallet drum 6 rotates together with the upper cover plate 7 and the switching disk 24, whereas the switching cams 22, the shift linkage 9, the yoke 16 and the guide rods 21 have a constant rotary position. When the upper cover plate 7 is lifted, the switching disk 24 is suspended from the switching cams 22 and/or the connection flange 23.

The motor 3 is supported on linear units 31 such that it is displaceable in a vertical direction. With the aid of a third rotary bolt 32, the motor 3 can be raised from a lower operating position 33 to an upper retrofitting position 34 for removing the gluing drum 2. In the course of this movement, the motor 3 and the third rotary bolt 32 execute the first stroke 5. The shift linkage 9 preferably causes the first stroke 5 to be converted into a smaller second stroke 20. The operating force required for raising the upper cover plate 7 is therefore smaller on the driving end of the shift linkage 9 than on the output side of the shift linkage 9. This is due to the different effective lever lengths 12c, 15c of the first and second levers 12a, 15a and/or the different absolute angular positions 12d, 15d of the first and second levers 12a, 15a. In FIG. 3 this is outlined schematically.

The relative angular position of the first and second levers 12a, 15a additionally causes an inversion of direction of the guide rods 21 and of the switching cams 22 at a lower reversal point of their lift movement, at which the cover plate 7 has been lowered by the second stroke 20 down to the lower operating position 27. The lifting rods 21 then execute first a downward directed partial stroke 21a for pushing the cover plate 7 fully into its operating position 27 and, subsequently, an upward directed partial stroke 21b so as to eliminate the force fit connection between the switching cams 22 and/or connection flange 23 and the switching disk 24. To this end, the switching cams 22 are positioned in a suitable manner within the certain amount of clearance in the guide groove 25. To make things clearer, the partial strokes 21a, 21b are not drawn to scale.

The mode of operation of pushing the second rotary bolt 15 beyond the reversal point, at which the second lever 15a is directed vertically downwards, can be seen in FIG. 3. This figure shows the no-load position of the lifting rods 21 after pushing beyond the reversal point in an anti-clockwise direction. Lifting of the motor 3 from this position causes a clockwise rotation of the second lever 15a first down to the lower reversal point of the lifting rods 21, corresponding to the dead center of the shift linkage 9, and subsequently a lift movement of the lifting rods 21 and of the cover plate 7 suspended therefrom. Hence, lifting as well as pressing-on of the cover plate 7 and the subsequent relief of the lifting mechanism on the output side are caused by the lift movement of the motor 3 alone. At the no-load position shown, the first and second levers 12a, 15a each define with the vertical a respective acute angle 12d, 15d with opposite signs. This is symbolized by oppositely directed arrows 12d, 15d in FIG. 3.

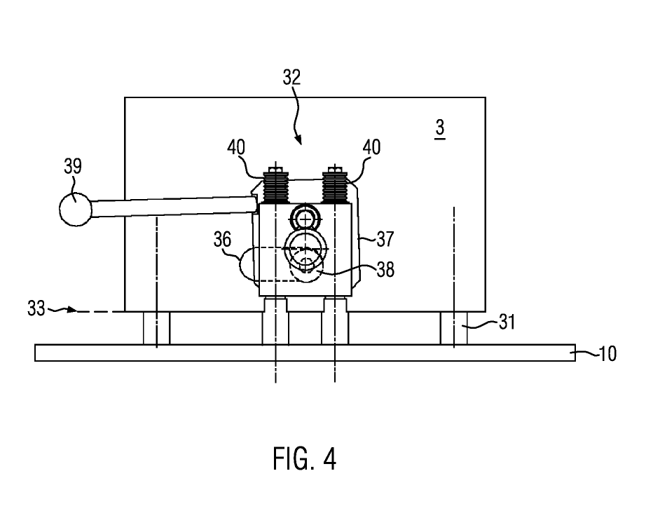

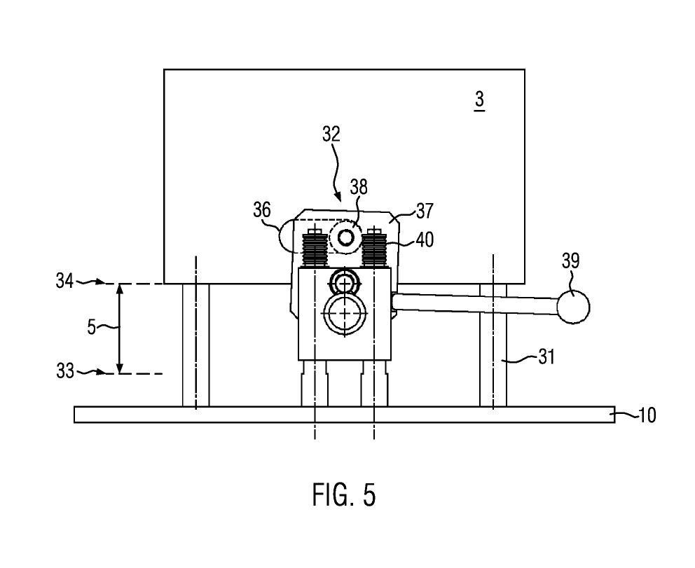

The shifting shaft 19 of the shift linkage 9 is supported e.g. in a bearing block 35, which is fixedly connected to the support frame 10, such that it is rotatable about a horizontal axis of rotation 19′. The third rotary bolt 32 is preferably formed on a second wall section 3b of the motor 3, said second wall section 3b being located on the opposite side of the first rotary bolt 12. In correspondence with the first guide groove 13, the second housing section 3b has formed therein/thereon a second guide groove 36 for the third rotary bolt 32. This is schematically outlined in FIGS. 4 and 5.

FIG. 4 illustrates the mode of operation of the third rotary bolt 32 during lifting of the motor 3. FIG. 4 shows the motor 3 at the lower operating position 33, and FIG. 5 shows it at the upper retrofitting position 34. According to these figures, the third rotary bolt 32 comprises an eccentric 37 having supported thereon a third switching roller 38. This switching roller 38 engages the second guide groove 36 of the motor 3. Rotating the eccentric 37 by means of an operating lever 39, in the present example by approx. 180° , leads to the change in position of the motor 3 between the lower operating position 33 and the upper retrofitting position 34. In addition, the third rotary bolt 32 may have provided thereon spring elements 40, which push the motor 3 e.g. downwards so as to keep the connection to the gluing drum 2 in a preloaded condition and/or so as to arrest the motor 3 at the upper retrofitting position 34 by pushing the eccentric 37 beyond a dead center.

Instead of the different effective lever lengths 12c, 15c and/or the absolute rotary positions 12d, 15d of the first and second levers 12a, 15a of the shift linkage 9, or in addition thereto, a transmission ratio of the shift linkage 9 may be realized by means of interengaging shifting shafts 19 on the bearing block 35.

The third rotary bolt 32 may be replaced or supplemented by other displacement means for lifting the motor 3. Imaginable are toggle levers, threaded spindles or the like. The displacement means for the motor 3 may also be driven electrically, pneumatically or the like. The decisive aspect is that a drive acting on the upper cover plate 7 can be produced with the aid of the shift linkage 9 according to the present disclosure so as to lift the motor 3 and the cover plate 7 synchronously by means of a single manual drive or motor drive. Furthermore, the cover plate can be fully pressed on by lowering the motor 3 onto the pallet drum 6 and, when a dead center of the shift linkage 9 has been exceeded, the lift movement of the guide rods 21 carrying the cover plate 7 can be reversed and the connection between the shift linkage 9 and the cover plate 7 mechanically relieved.

What is claimed is:

1. A labeling unit for containers, comprising:
a gluing drum;
a vertically displaceable motor for driving the gluing drum;
a pallet drum with an upper cover plate that is adapted to be lifted upwards; and
a shift linkage by means of which the cover plate is coupled to a housing section of the motor such that, when the motor is displaced upwards, the cover plate is lifted together therewith.

2. The labeling unit according to claim 1, wherein the shift linkage is configured such that the cover plate can be raised from a lower operating position for supporting gluing pallet shafts to an upper retrofitting position for exchanging the gluing pallet shafts.

3. The labeling unit according to claim 1, wherein the shift linkage comprises a first rotary bolt, which is coupled to the motor such that a stroke of the motor is converted into a rotary movement of the shift linkage.

4. The labeling unit according to claim 3, wherein the first rotary bolt has formed thereon a switching roller which engages a guide groove formed on the motor.

5. The labeling unit according to claim 3, wherein the shift linkage additionally comprises a second rotary bolt which is coupled to the cover plate such that the rotary movement is converted into a stroke of the cover plate.

6. The labeling unit according to claim 5, wherein the first and the second rotary bolts differ from one another with respect to at least one of effective lever lengths or absolute rotary positions of the levers.

7. The labeling unit according to claim 6, wherein the at least one of effective lever lengths or absolute rotary positions of the levers differ such that the second rotary bolt executes a stroke that is smaller than that of the first rotary bolt.

8. The labeling unit according to claim 5, wherein the second rotary bolt is coupled to the cover plate by means of a plurality of vertically guided lifting rods.

9. The labeling unit according to claim 8, wherein the second rotary bolt can be pushed beyond a reversal point such that, at a lower reversal point, at which the cover plate is at a lower operating position, the lifting rods change from a downward directed partial stroke to an upward directed partial stroke.

10. The labeling unit according to claim 8, wherein the cover plate has secured thereto a coaxial switching disk with a circumferentially extending groove, and wherein the lifting rods have secured thereto switching cams engaging said groove and/or a connection flange engaging said groove so as to transmit a lifting force to the switching disk.

11. The labeling unit according to claim 10, wherein the switching cams have a certain amount of vertical clearance in the groove, especially such that the switching cams can move freely at a lowered operating position of the cover plate.

12. The labeling unit according to claim 1, further comprising a third rotary bolt for adjusting the vertical position of the motor.

13. The labeling unit according to claim 12, wherein the third rotary bolt comprises an eccentrically supported switching roller which engages a guide groove formed on the motor.

14. The labeling unit according to claim 12, wherein the third rotary bolt is formed on a housing section of the motor located opposite the shift linkage.

15. The labeling unit according to claim 1 wherein the motor is adapted to be displaced upwards from an operating position above the gluing drum.

16. The labeling unit according to claim 15, the motor being displaced linearly in a vertical direction.
